(19) United States
(12) Patent Application Publication
(10) Pub. No.: US 2008/0043965 A1
(43) Pub. Date: Feb. 21, 2008

(54) Provision and Management of Conference Websites

(75) Inventors: Steven M. Cellini, Redmond, WA (US); Charles Joseph Torre, Seattle, WA (US); Andrew David Corran, Snoqualmie, WA (US); Hans Hugli, Redmond, WA (US); Scott V. Fynn, Seattle, WA (US); George M. Moore, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/461,647

(22) Filed: Aug. 1, 2006

(51) Int. Cl. H04M 3/42

(52) U.S. Cl. 379/205.01

(57) ABSTRACT

Techniques are described to provision and manage conference websites. In one or more implementations, a website is provided for each of a plurality of conference attendees. Each of the websites includes a respective copy of materials related to a conference, which may be modifiable by respective conference attendees.

### BACKGROUND

When attending a conference, the attendees are generally provided with materials to support interaction with the conference, such as literature describing products that are to be shown at the conference, lecture-supporting texts, and so on. Traditional materials were limited, however, in their ability to be shared with others, the “richness” that was supported, and/or the ability to modify the materials and share those modifications with others.

A conference attendee, for example, may attend a conference that is of interest to other people, such as coworkers within a company. For a variety of reasons, however, the coworkers may not be able to attend the conference, such as due to scheduling conflicts or budget constraints. Therefore, the coworkers were traditionally limited to interaction with materials provided to the conference attendee, such as paper handouts and so on. Thus, these materials were important not only to the attendee that attended the conference but to others as well.

One technique that was used to provide “rich” conference-related materials that may be shared involved physical distribution of a computer-readable medium (e.g., a digital video disk (DVD), a flash drive, and so on) having conference-related materials to the attendees. Consequently, the materials provided to the attendees using this technique were limited by the computer-readable medium, such as an amount of storage space, limited to local execution of executable code included on the medium, and so forth. Further, these materials were difficult to share with other people, such as the coworkers that did not attend the conference as discussed in the previous example.

### SUMMARY

Techniques are described to provision and manage conference websites. In one or more implementations, a website is provided for each of a plurality of conference attendees. Each of the websites includes a respective copy of materials related to a conference.

The websites having the materials may also be managed in a variety of other ways. In an implementation, the materials are modifiable by respective conference attendees. In another implementation, the websites are created when one or more unique identifiers relating to the conference are received, such as identifiers provided to conference attendees by a host of the conference. Thus, in this implementation the websites may be created “on demand”. In a further implementation, the websites are managed such that when a change is made to a source of the materials copied to the website, the change is made to each copy of the conference-related materials included in the respective websites. A variety of other implementations are also contemplated.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an exemplary implementation that is operable to employ techniques to provision and manage websites related to a conference.

FIG. 2 is an illustration of a system in an exemplary implementation showing a conference service and client of FIG. 1 in greater detail.

FIG. 3 is an illustration of an exemplary implementation of a user interface, obtained from a conference service, which is displayable via a display device of the client of FIG. 2 to obtain access to a website.

FIG. 4 is a flow diagram depicting a procedure in an exemplary implementation in which a website is created and provisioned for an attendee of a conference.

FIG. 5 is a flow diagram depicting a procedure in an exemplary implementation in which conference websites of FIGS. 1 and 2 are managed by a conference service using a variety of techniques.

### DETAILED DESCRIPTION

Overview

Traditional techniques that were used to provide materials related to a conference were limited. For example, traditional conference-related materials were limited in their ability to be shared (e.g., by passing around a paper copy of the materials), limited by a medium used to distributed the materials (e.g., an amount of storage space on a computer-readable medium that was physically distributed to the conference attendees), and so on.

For example, software engineers attending a software-related conference may be given a computer-readable medium containing conference proceedings, supporting documentation, beta-code of software to be released, and so on. For primarily client-centric software such a technique was sufficient to provide a copy of the software that could be executed and tested locally by the attendee. However, as software is moved “into the cloud” to be provided by relatively large web services (e.g., an email service having millions of subscribers that is supported by thousands of servers) it may become difficult to provide beta versions of the software on computer-readable media that is to be physically distributed to attendees of the conference. For example, service-oriented software is often a building block of a larger distributed application, and therefore the education benefit of the installing, testing and/or modifying the software may be greater when hosted online with connectivity to other services.

Accordingly, techniques are described in which conference websites are provided and managed to provide access to conference-related materials. For example, each attendee of a conference may be given a respective website that is accessible via a unique domain. These websites may act as a “sandbox”, in which, the respective attendees may interact with materials related to the conference. The materials, for instance, may include isolated copies of beta code that is executable “over the cloud” and modifiable by respective users. Therefore, each attendee may be provided with a unique area that is modifiable as desired, such as to upload additional executable code, to modify the executable code that relates to the conference, and so on. Thus, the “sandbox” may provide an area that directly supporter iterative modification of software, such as for experimentation and so on.

The websites may be provided and managed in a variety of ways. For example, the websites may be created “on demand” as identifiers of conference attendees are received, thereby conserving resources used to provide the websites. In another example, the websites may be managed such that changes made to a source of the conference materials are automatically promulgated to copies of the materials maintained in each of the websites. In this example, the copies of the conference materials may also stay isolated with respect to each other such that a change made to a copy is not promulgated to other copies unless that change is also made to a source of the copies. A variety of other examples are also contemplated, further discussion of which may be found in relation to the following figures.

In the following discussion, an exemplary environment is first described that is operable to perform techniques to provision and manage conference websites. Exemplary procedures and user interfaces are also described that may be employed in the exemplary environment, as well as in other environments.

Exemplary Environment

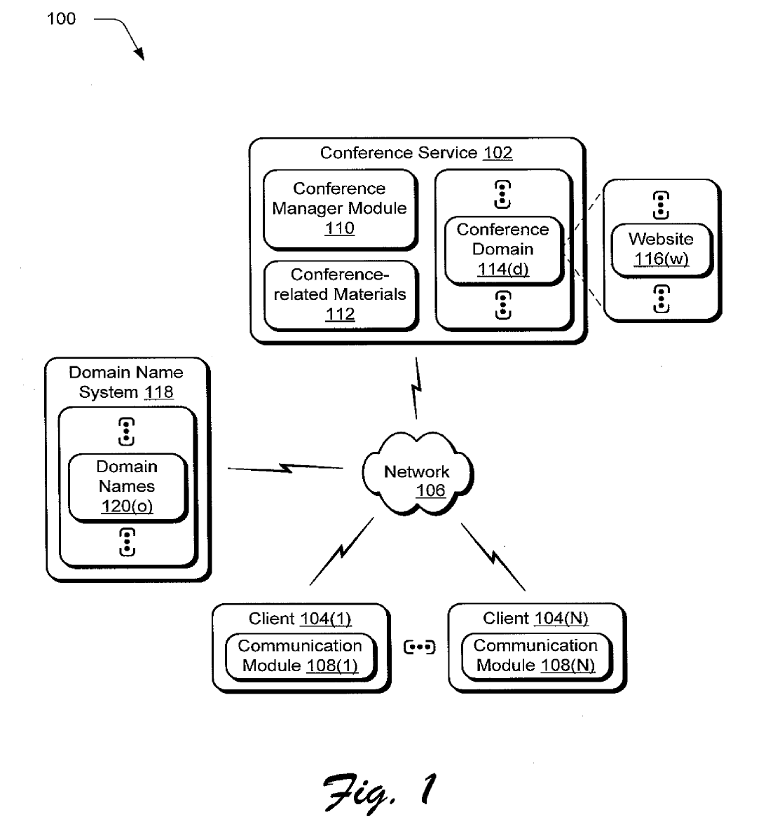

FIG. 1 is an illustration of an environment 100 in an exemplary implementation that is operable to employ techniques to provision and manage conference websites. The illustrated environment 100 includes a conference service 102 and a plurality of clients 104(1), . . . , 104(N) that are communicatively coupled, one to another, via a network 106. In the following discussion, the conference service 102 may be representative of one or more entities, and therefore reference may be made to a single entity (e.g., the conference service 102) or multiple entities (e.g., the conference services 102).

The clients 104(1)-104(N) may be configured in a variety of ways for network 106 access. For example, one or more of the clients 104(1)-104(N) may be configured as a computing device, such as a desktop computer, a mobile station, an entertainment appliance, a set-top box communicatively coupled to a display device, a wireless phone, a game console, and so forth. Thus, the clients 104(1)-104(N) may range from full resource devices with substantial memory and processor resources (e.g., personal computers, game consoles) to low-resource devices with limited memory and/or processing resources (e.g., traditional set-top boxes, hand-held game consoles). The clients 104(1)-104(N), in portions of the following discussion, may also relate to a person and/or entity that operate the clients. In other words, one or more of the clients 104(n) may describe logical clients that include users (e.g., a conference attendee), software, and/or devices.

Although the network 106 is illustrated as the Internet, the network may assume a wide variety of configurations. For example, the network 106 may include a wide area network (WAN), a local area network (LAN), a wireless network, a public telephone network, an intranet, and so on. Further, although a single network 106 is shown, the network 106 may be configured to include multiple networks.

Each of the clients 104(1)-104(N) is illustrated as having a respective communication module 108(1)-108(N). The communication modules 108(1)-108(N) are representative of functionality to provide communication over the network 106, such as with the conference service 102. For example, the communication modules 108(1)-108(N) may be configured as a web browser that allows the clients 104(1)-104(N) to “surf” the Internet. In another example, the communication modules 108(1)-108(N) are configured as a “smart” module that is configured to provide other network functionality as a part of its operation, such as an instant messaging module, an email module, an online banking module, and so on. A wide variety of other examples are also contemplated.

The conference service 102 as illustrated in FIG. 1 includes a conference manager module 110, conference-related materials 112 and one or more conference domains 114(d) (where “d” can be any integer from one to “D”) to provide one or more websites 116(w) (where “w” can be any integer from one to “W”). The conference manager module 110 is representative of functionality to provide the websites 116(w) and conference-related materials 112 over the network 106 to the clients 104(1)-104(N).

The conference manager module 110, for instance, may interact with a domain name system (DNS) 118 over the network 106. The DNS 118 is employed in the environment 100 to maintain a relationship between Internet Protocol (IP) addresses and domain names 120(o), where “o” can be any integer from one to “O”. For example, the DNS 118 may be implemented by a plurality of servers distributed “across” the Internet that maintain lists that reference the correspondence of the domain names 120(o) with respective IP addresses. By interacting with the DNS 118, the conference manager module 110 may obtain domains (e.g., the conference domains 114(d)) for each contemplated attendee of a conference, such as “http://xxxxxx.conferencesandbox.com” where “xxxxxx” is replaced with a unique identifier, such as a numerical identifier, a “user friendly” name (e.g., “JohnSmith.conferencesandbox.com”), and so on. In this way, the domains may make the previously described sandboxes “first-class citizens” of the Internet and thus tools and functionality enabled through the Internet may be realized in the respective sandboxes, i.e., the conference domains 114(d).

The conference manager module 110 may also provision the conference domains 114(d) with conference-related materials 112, such as related promotional materials and so on and then expose these materials as websites 116(w) accessible via the respective conference domains 114(d). In an implementation, the conference-related materials 112 of the respective websites 116(w) are modifiable by a respective attendee of the conference. The websites 116(w) may also include additional storage for other data by a respective attendee, such as to upload additional executable code. In this way, the attendees may shape and mould the respective websites as desired. Further, the contents of the websites 116(w) may be exposed over the network 106 to users that are not attending the conference. For instance, conference attendees may share information contained in the webpage 116(w) with their coworkers, thereby efficiently disseminating the conference-related materials 112. Further, this information may be shared in real time which promotes increased interaction and collaboration.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, for instance, the module, functionality, or logic represents program code that performs specified tasks when executed on a processor (e.g., CPU or CPUs). The program code can be stored in one or more computer readable memory devices. The features of the techniques to provision and manage conference websites described below are platform-independent, meaning that the techniques may be implemented on a variety of commercial computing platforms having a variety of processors.

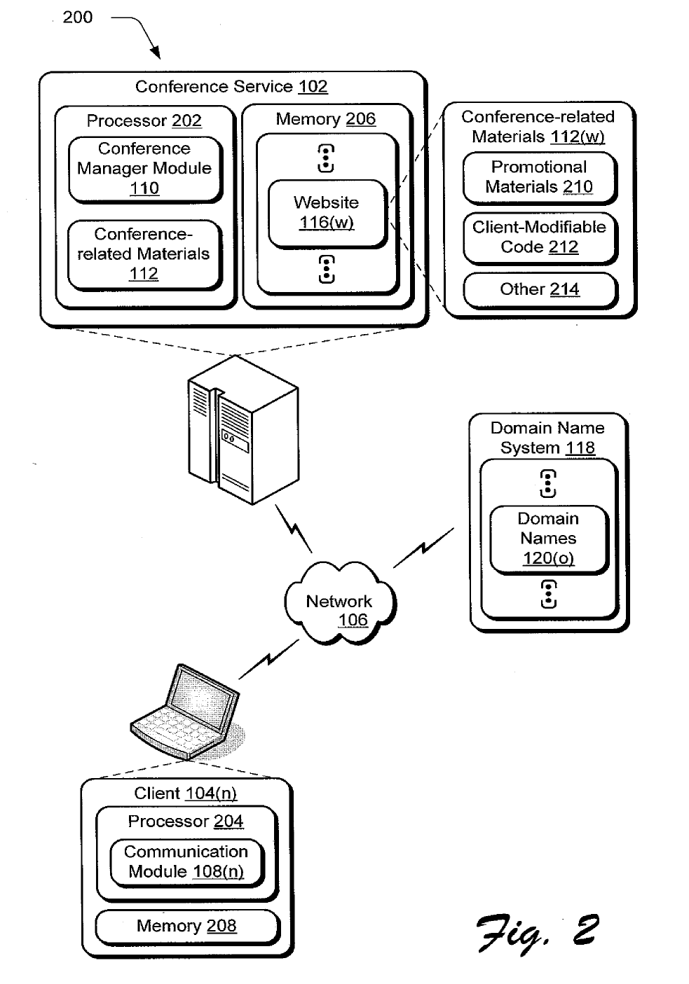

FIG. 2 is an illustration of a system 200 in an exemplary implementation showing the conference service and clients of FIG. 1 in greater detail. The conference service 102 is illustrated in FIG. 1 as being implemented by a server and the client 104(n) (which may correspond to one or more of the clients 104(1)-104(N) of FIG. 1) is illustrated as a client device, each of which having respective processors 202, 204 and memory 206, 208. In the following discussion, the client 104(n) may be representative of one or more entities, and therefore reference may be made to a single entity (e.g., the client 104(n)) or multiple entities (e.g., the clients 104(n), the plurality of clients 104(n), and so on).

Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth. Additionally, although a single memory 206, 208 is shown respectively, for the conference service 112 and the client 104(n), a wide variety of types and combinations of memory may be employed, such as random access memory (RAM), hard disk memory, removable medium memory, and other types of computer-readable media.

The conference service 102 is illustrated as executing the conference manager module 110 on the processor 202, which is also storable in memory 206. As previously described, the conference manager module 110 is representative of functionality to create, provision and manage websites 116(w). For example, the conference manager module 110 may be executed to obtain unique domain names 120(o) from the domain name system 118 for each expected attendee of a conference. These unique domain names may then be used to access websites 116(w) created by the conference service 102.

The conference manager module 110, for instance, may provision the websites 116(w) by copying a source of conference-related materials 112 to each of the websites 116(w), the respective copies being illustrated as conference-related materials 112(w) in FIG. 2. As previously stated, the conference-related materials 112(w) may be configured in a variety of ways, such as electronically storable copies of promotional materials 210, client-modifiable code 212, and other 214 materials.

The client-modifiable code 212, for instance, may be a copy of a beta version of a web service that is to be tested by the client 104(n). The client 104(n), therefore, may interact with the client-modifiable code 212 in a variety of ways, such as to run tests, modify the code 212, upload additional code to the website 116(w), and so on. Additionally, by providing this code 212 via the website 116(w), the client 104(n) may readily share the code 212, such as with coworkers and so on. In an implementation, the website 116(w) is made available well after the conference has terminated to preserve access to the conference-related materials 112(w), such as to continue an opportunity of the client 104(n) to modify and interact with the code 212. In another implementation, the website 116(w) is set to “expire” after a predetermined amount of time.

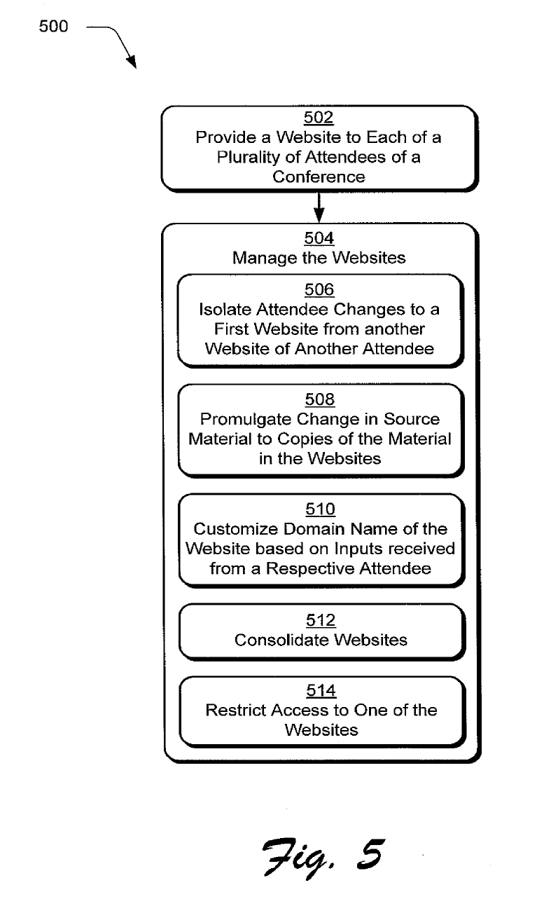

The conference service 102, through execution of the conference manager module 110, may manage the websites 116(w) in a variety of ways. For example, the conference manager module 110 may maintain a source of the conference-related materials 112 and copy the materials 112 to the websites 116(w) when created. Additionally, when changes are made to the source, the changes may be promulgated to the copies, which may be performed automatically and without user intervention. For instance, the changes may be made to the copies (e.g., conference-related materials 112(w)) without notifying a respective attendee, may be made upon acceptance by the respective attendee, may be made by saving a new version of the conference-related materials, and so on. Further, the copies themselves may remain isolated from each other, such that changes made to one copy by a respective attendee are not made to another copy maintained in another website for another attendee of the conference. Additional discussion of website management may be found in relation to FIG. 5.

The websites 116(w) may also be created in a variety of ways. For example, the conference manager module 110 may create a unique identifier for each expected attendee of the conference. The unique identifiers may then be distributed to the respective attendees, such as via email, printed materials distributed at the conference and so on. The client 104(n), through execution of communication module 108(n), may then enter the unique identifier via a user interface.

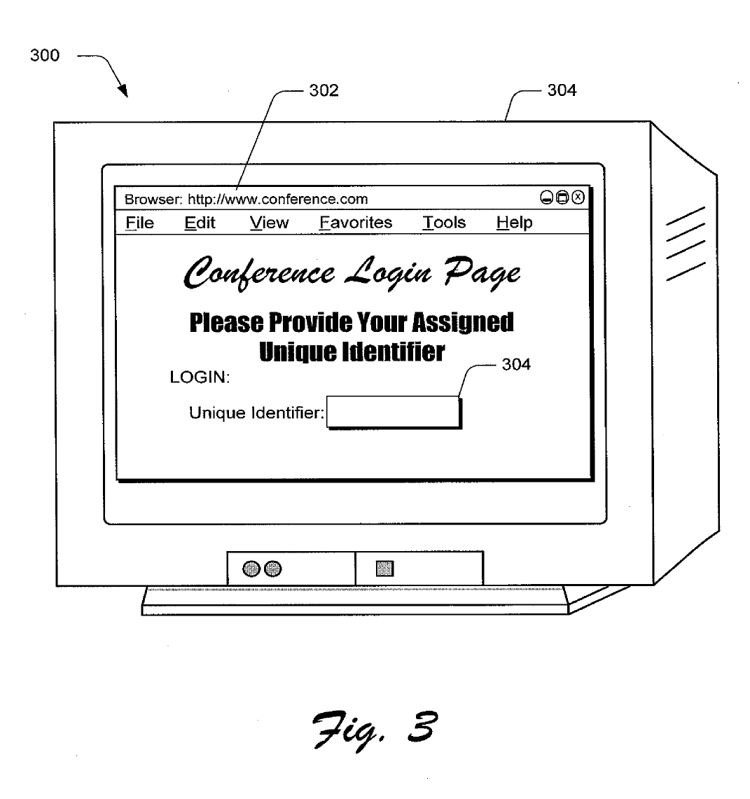

FIG. 3, for example, illustrates an exemplary implementation 300 of a user interface 302 displayable via a display device 304 of the client 104(n) of FIG. 2. The user interface 302 is accessible via a website that accepts input of a unique identifier 306. Upon receipt of the unique identifier, the conference service 102 may direct the client 104(1) to a respective website 116(w).

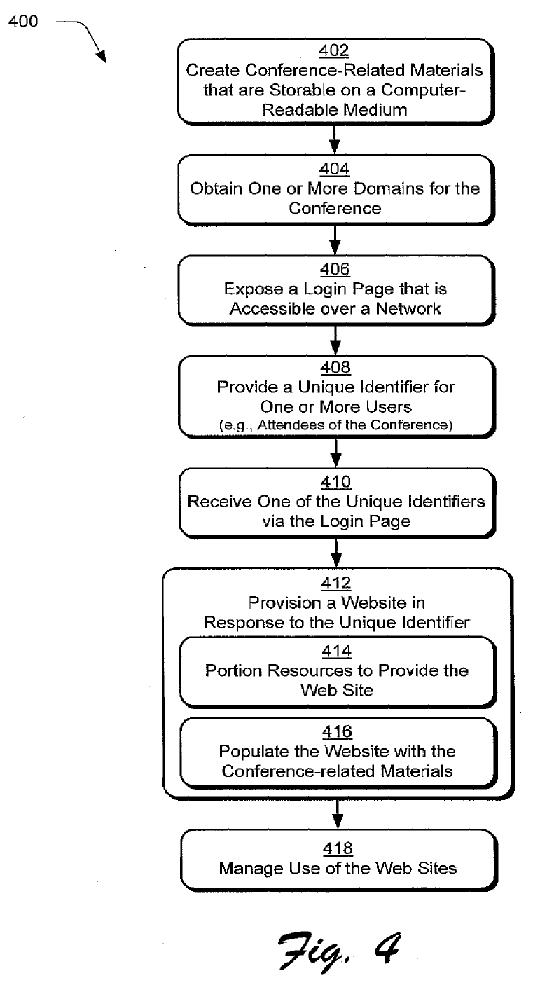

In an implementation, the websites 116(w) are created “on demand” upon receipt of the unique identifier. For instance, when the conference manager module 110 receive the unique identifier via the login screen of FIG. 3, it may select a conference domain 114(d) obtained form the domain name system 118 and create a website 116(w) at the selected domain. The website 116(w) may then be provisioned with conference-related materials 112 and exposed to the respective attendee. Thus, in this instance resources are not expended to provide the website 116(w) until confirmation is received from an attendee that use of the website 116(w) is desired. Further discussion of website creation and provisioning may be found in relation to FIG. 4.

Exemplary Procedures

The following discussion describes provisioning and management techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1, the system 200 of FIG. 2 and the user interface of FIG. 3.

FIG. 4 depicts a procedure 400 in an exemplary implementation in which a website is created and provisioned for an attendee of a conference. Conference-related materials are created that are storable on a computer-readable medium (block 402). The conference related materials, for instance, may be electronically-stored copies of paper handouts to be distributed at the conference, technical brochures, executable code, and so on.

One or more domains are obtained for the conference (block 404). For example, the conference service 102 may communicate with the domain name system 118 to obtain domains. A variety of different domains may be obtained, such as domain names having a title that corresponds to the conference, a domain that corresponds to attendees of the conference (e.g., based of their registered domain, if any, such as “attendee_name_conference.com”), and so on.

A login page is exposed that is accessible over a network (block 406). The user interface 302 of FIG. 3, for instance, may be exposed such that a client 104(n) may access the page over the Internet to login to the conference service 102.

One or more unique identifiers may be provided for one or more users (block 408), such as to attendees of the conference. The conference manager module 110 and/or a user of the conference service 102, for instance, may generate the unique identifiers based on the conference attendee's name, randomly generate the unique identifiers, incorporate a portion of a domain name obtained for the conference, and so on.

One or more of the unique identifiers are received via a login page (block 410). For example, a conference attendee may enter a provided unique identifier by using a browser to communicate with the conference service 102 via the network 106.

A web site is provisioned in response to reception of the unique identifier, (block 412). The conference manager module 110, for instance, may identify a particular conference that corresponds to the unique identifier, verify that the unique identifier is valid, and so on. Resources of the conference service 102 are then portioned to provide the web site (block 414), such as by configuring hardware, software and network resources to make the website 116(w) accessible via the network 106. The website is also populated with conference-related materials (block 416), such as copies of the conference-related materials previously created in block 402. In this way, the website 116(w) is created “on demand” in response to receipt of an input from an conference attendee and thereby efficiently utilizes resources. The conference service 102 may then manage use of the website (block 414), further discussion of which may be found in relation to the following figure.

FIG. 5 depicts a procedure 500 in an exemplary implementation in which conference websites of FIGS. 1 and 2 are managed by a conference service 102 using a variety of techniques. A website is provided to each of a plurality of attendees of a conference (block 502). As described in relation to FIG. 4, for instance, the websites may be created “on demand” as the attendees login to the conference system 102. In another instance, the websites are created and exposed before login by a conference attendee. A variety of other instances are also contemplated.

The websites are managed (block 504) by the conference service 102 using a variety of techniques. For example, changes made by an attendee to a corresponding first website may be isolated from another website of another attendee (block 506). Thus, in this example each attendee is provided their own virtual “sandbox” in which to interact with conference-related materials and that interaction is kept from “spilling over” into other sandboxes, i.e., the other websites.

In another example, the conference service 102 manages the websites such that a change in source material is promulgated to copies of the material included in the websites (block 508). For instance, a presenter at the conference may provide the conference-related materials and have those included on each of the websites. Subsequently, a change may be made to the materials and that change may be automatically promulgated to each of the websites through execution of the conference manager module. A variety of other instances are also contemplated, such as through use of a “sharing” technique in which a virtual folder mechanism is employed.

In a further example, the domain name of the website may be customized based on inputs received from a respective attendee (block 510). The attendee, for instance, may change a previously assigned domain name, request the domain name before creation of the website, and so on.

In yet another example, the websites are consolidated (block 512), such as by combining a created website for a conference with another website for another conference, with a website offered by another service provider (e.g., a business website), and so on.

In still yet another example, access to one of the websites is restricted (block 514). The attendee, for instance, may specify a sub-domain, from which, access is permitted, such as a work sub-domain, may specify a particular collection of users (e.g., “friends” of the attendee), and so on. Although a variety of management examples have been discussion, it should be readily apparent that a wide variety of other management techniques may also be employed without departing from the spirit and scope thereof.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
receiving one or more unique identifiers that correspond to a particular conference; and
when each said unique identifier is received, creating and provisioning a respective website with materials related to the particular conference.

2. A method as described in claim 1, wherein the conference-related materials are promotional materials related to the conference.

3. A method as described in claim 1, wherein the conference-related materials include executable code that is modifiable by a user having access to the provisioned website.

4. A method as described in claim 3, wherein a modification made to code in a first said website does not affect the code in a second said website.

5. A method as described in claim 1, wherein at least one said website is configured to accept code uploaded by a conference attendee that was assigned a corresponding said unique identifier.

6. A method as described in claim 1, wherein the unique identifiers are received via a login page.

7. A method as described in claim 1:
further comprising obtaining one or more domains for the conference; and
wherein the creating includes portioning hardware and software resources of one or more servers to provide each said website.

8. A method as described in claim 1, further comprising:
creating the one or more unique identifiers by a host of the conference; and
providing the one or more unique identifiers created by the host to attendees of the conference.

9. A method as described in claim 8, wherein the one or more unique identifiers are provided via email sent to respective said attendees of the conference.

10. A method as described in claim 1, further comprising receiving an input to customize a domain name of a respective said website.

11. A method as described in claim 1, wherein at least one said website is created from an existing domain of a respective attendee of the conference.

12. A method as described in claim 1, further comprising consolidating a website for the particular conference with another website from another conference.

13. A method comprising:
providing a website to each of a plurality of attendees of a conference, wherein each said website includes materials related to the conference; and
receiving inputs from at least one said attendee to modify the materials in a respective said website.

14. A method as described in claim 13, wherein each said website is provided on demand to respective said attendees.

15. A method as described in claim 13, wherein the materials include executable code that is modifiable by respective said attendees.

16. A method as described in claim 13, wherein:
each said website is configured such that when a change is made to a source of the materials, the change is automatically propagated to each copy of the materials included in the respective said websites; and
a change made by a respective said attendee to the materials of a first said website is not propagated to the materials of a second said website.

17. One or more computer-readable media comprising executable instructions that, when executed, direct a computer to:
provide a website for each of a plurality of conference attendees, wherein each said website includes a respective copy of materials related to a conference; and
when a change is made to a source of the materials, make the change to each said copy of the materials included in the respective said websites.

18. One or more computer-readable media as described in claim 17, wherein the copies of the materials are configured such that when a change is made to the copies, the changes do not affect other copies of the materials.

19. One or more computer-readable media as described in claim 17, wherein the materials include executable code that is modifiable by a user having access to the respective said website.

20. One or more computer-readable media as described in claim 17, wherein each said website was created and provisioned in response to receipt of one or more unique identifiers that correspond to the conference.
